(19) United States
(12) Patent Application Publication
(10) Pub. No.: US 2005/0237944 A1
(43) Pub. Date: Oct. 27, 2005

(54) Automatic route configuration for quasi-associated m3ua connections

(76) Inventor: Manfred Angermayr, Schrobenhausen (DE)

Correspondence Address: Siemens Corporation;Intellectual Property Department, 170 Wood Avenue South, Iselin, NJ, 08830, US

(21) Appl. No.: 10/512,463

(22) PCT Filed: Apr. 24, 2003
(86) PCT No.: PCT/DE03/01335

§ 371 Date: Oct. 22, 2004

(30) Foreign Application Priority Data
Apr. 26, 2002 (DE) 102 18 809.2

(51) Int. Cl. H04L 12/28

(52) U.S. Cl. 370/254

(57) ABSTRACT

The invention relates to a method used in a packet-based telecommunications network that is designed in particular for network nodes that act as signalling transfer points. Said method is used to distribute information concerning the network topology. The network nodes contain information concerning distances between the network nodes and potential target network nodes for future message transmissions. The information can be distributed within the framework of registration requests, for example by means of the M3UA protocol. Said information can be used in the network nodes for establishing a routing database.

### CROSS REFERENCE TO RELATED APPLICATIONS

This application is the US National Stage of International Application No. PCT/DE03/01335, filed Apr. 24, 2003 and claims the benefit thereof. The International Application claims the benefits of German application No. 10218809.2 filed Apr. 26, 2002, both of the applications are incorporated by reference herein in their entirety.

### FIELD OF INVENTION

The present invention relates to a method for use in packet-based telecommunications systems, wherein topological features of the network are determined by means of the method and are taken into account during route selection.

### BACKGROUND OF INVENTION

Network nodes in a telecommunications system can be designed for different functions. In a network with separate user information and signaling channels, for example, a network node may be present in the form of a signaling transfer point (STP). In an STP of this kind the signaling messages are only forwarded. The actual processing of the signaling information, on the other hand, takes place in what are referred to as the signaling end points (SEPs).

A network node may also be present in the form of a gateway. In this case it forms a connecting network node between different networks. A gateway by means of which signaling messages can be processed and/or forwarded is referred to as a signaling gateway (SG). An SG can, for example, connect an Integrated Services Digital Network (ISDN) to the Internet.

A connection-oriented telephone network is connected to packet-based networks, for example the Internet, by means of a media gateway (MG). The media gateway processes in particular voice signals for their further processing in the respective other network.

A media gateway controller (MGC) is responsible for controlling the media gateways. The MGC operates in the signaling network like an SEP in the Internet Protocol (IP) network. An MGC is typically connected via an SG to the Signaling System Number 7 (SS7) network.

SGs can be embodied with STP functionality, in other words serve in particular as routers for signaling messages. When signaling is performed via STPs, this is referred to as ‘quasi-associated’ signaling.

Communication between the network nodes takes place on the basis of protocols which control the information exchange. A number of interworking protocols are referred to as a protocol family. An example of a protocol family of this kind is the SS7 system, which is used in digital telecommunications networks for signaling between the network nodes.

That part of SS7 which controls the message transmission is called the ‘Message Transfer Part’ (MTP). If it is wished to transport the SS7 signaling information via an IP network, what is referred to as the ‘MTP Level 3 User Adaptation’ (M3UA) is used instead of the MTP. The M3UA is connected to the MTP via an interworking function. The M3UA is used, for example, to transmit the signaling between MGC and SG or, as the case may be, between two SGs.

What is referred to as the ‘dynamic configuration function’ is also part of the M3UA protocol and is used to register an MGC with an SG. For this purpose a ‘registration request’ is sent by the MGC to the SG, said registration request containing the address of the MGC in the SS7 network in the form of the ‘point code’. The MGC together with its point code can be deregistered from an SG by means of a corresponding deregistration request.

SEPs have no transfer function. Thus, even though they transmit registration requests relating to their own point code, they do not forward other registration requests. This applies in particular also to MGCs.

Route selection for message transfers in a packet-based telecommunications network can be effected by STPs or gateways in that the data packets are forwarded section by section from one network node to the next. The section on a route that lies between two network nodes is referred to in the following as a sublink. The data packets are routed through the network on the basis of information contained in the routing databases which are present in the network nodes. In this case the address of a data packet is typically specified by means of the ‘destination point code’ (DPC).

It is known from EP 1 056 246 A2 that routers in packet-based data communication systems which are based on the IP can exchange information about available routes and in this way information about available sublinks can be collected in the routers.

The ‘Routing Information Protocol’ (RIP) is a special ‘Interior Gateway Protocol’ (IGP) within the framework of the IP which is used to distribute routing information in an autonomous network system. The ‘Open Shortest Path First’ (OSPF) protocol is a further IGP by means of which the routing can be optimized in respect of the transmission costs.

According to the current state of the art, in telecommunications systems which are based on the SS7 standard the routes are set up manually by the operator in each SG with STP functionality for all possible destination addresses. In this case, if there are several possible routes—and for security reasons this is the rule,—priorities corresponding to the possible routes must be assigned manually by the operator for each destination. This information is stored in the routing database. This database can be modified likewise only by manual interventions on the part of the operator. This therefore generates an administrative overhead.

The route via which a message is sent depends on the current status of the routes. In an STP, of the available routes, that route which has the highest priority is selected in each case for transmitting a message. If this route fails, an alternate route with lower priority is used.

### SUMMARY OF INVENTION

The object of the invention is to automate to the maximum possible extent or to some extent the process of setting up a routing database in an SS7 network or in a network with corresponding characteristics.

This object is achieved by means of the methods specified in the independent claims. Advantageous embodiments of the invention are specified in the dependent claims.

According to the invention, information concerning a distance is sent by a network node, designated by A below, in a first step a.) to its immediately adjacent network node as part of a registration request.

The network can be for example an SS7 network. The network node ‘A’ can be in particular an SEP, for example an MGC. The immediately adjacent network nodes can be in particular STPs, for example in the form of SGs. The registration request can be, for example, an MTP or an M3UA message.

‘Distance’, in this context, refers to the number of sublinks on a specific route between two network nodes. For example, the route from a network node ‘k’ to a network node ‘m’ has the value two if it runs from ‘k’ to ‘m’ via a network node ‘l’, for in this case there are two sublinks present, the first from ‘k’ to ‘l’ and the second from ‘l’ to ‘m’.

If the M3UA protocol is used, as part of the implementation of the method according to the invention a further ‘tag’ for an additional parameter can be introduced into the already present registration request, which tag can be used to specify the distance value.

This form of distance specification corresponds to the specification of a distance between two network nodes in the form of what are referred to as ‘hop counts’.

The distance information transmitted by ‘A’ in the aforementioned first step of the method according to the invention relates to the distance from the network node ‘A’ to the network node ‘A’, in other words to itself. In this case the distance therefore has the value zero.

In addition to the value per se, the distance information transmitted by ‘A’ contains in particular also the identification of the sender of the message, in our case therefore the address of ‘A’, for example in the form of a point code.

According to the invention, the network node ‘A’ transmits the information to at least one directly adjacent network node. Of particular interest is the case where the information is sent to all those adjacent network nodes on which the method according to the invention has been implemented. It is desirable here that the method according to the invention can be performed with all directly adjacent network nodes of ‘A’, at least if they are operating as STPs, and ‘A’ accordingly sends the distance information to all these adjacent network nodes.

In a next step b.), the distance value sent by ‘A’ is incremented by one in a receiving adjacent network node, designated below by way of example by ‘X’, and stored in a step c.) together with the specification of the network node ‘A’ in the routing database of ‘X’.

In ‘X’, with the distance value modified by the aforementioned incrementation, a further distance is considered, namely the distance from ‘X’ to ‘A’. A sublink leads from ‘X’ to ‘A’, so consequently the distance value between ‘X’ and ‘A’ equals one.

For ‘X’, the network node ‘A’ now operates as a destination network node for a potential future transmission. Following the incrementation completed in step b.), the distance information received by ‘X’ is stored in ‘X’. This information can be stored, for example, in the routing table of ‘X’. Except for the distance value per se, in particular the potential destination network node—in our case, therefore, A—and as further routing information the next-following adjacent network node to be selected from ‘X’ on the route considered—in our case again ‘A’—is stored.

In a following step d.), the distance information modified by step b.) is forwarded by ‘X’ to at least one directly adjacent network node of ‘X’, designated below by way of example by ‘U’.

This message can be transmitted in turn for example as part of a registration request using the MTP or M3UA protocol.

Analogously to step a.), all network nodes on which the method according to the invention has been implemented are once again of particular interest in this case.

Similarly analogously to step a.), this distance information forwarded from ‘X’ contains in addition to the distance value per se—in our example, therefore, one—in particular the specification of the potential destination network node—in our case, therefore, ‘A’- and the information about the adjacent network node—in our example ‘X’- to be selected on this thus specified route from the adjacent network node of ‘X’—in our example, therefore, from ‘U’.

After these steps, therefore, the following information is present in ‘U’: If a transmission is to be performed from ‘U’ to ‘A’, this is possible on one route. In this case the distance value of this route from ‘U’ to ‘A’ is two and on this route a message from U is first to be sent to the adjacent network node ‘X’.

According to the invention, the steps b.) to d.) are now repeated. In our example, therefore, the distance information sent from ‘X’ to ‘U’ is in turn incremented by one in ‘U’ (step b.)), stored in the routing database of ‘U’ (step c.)) and again forwarded to immediately adjacent network nodes (step d.)).

Advantageously, the distance value that was calculated by the incrementation described in step b.) is not used in every case by a network node during forwarding of the distance information: If a smaller distance value for an alternate route is present in the routing database for the relevant destination network node, then this can be used for the forwarding. In this way the information is distributed via the shortest possible route in each case.

According to the invention, this method is continued until a defined abort criterion is met. This could be present, for example, if all the network nodes registered in the network receive the distance information originating from ‘A’. A further example of an abort criterion is the reaching of a previously specified maximum distance value. This is important for example in large networks, as otherwise unnecessarily large amounts of data could accumulate in routing databases and also unnecessary message transfer traffic could be generated.

After a certain time each network node receives distance information on potential destination network nodes by means of the method according to the invention. In particular the case is possible that after a certain time there are present in a network node two or more items of distance information for a specific destination network node which relate to different routes and have different values. In such a case the different routes for a potential destination network node are advantageously classified in the network node, in particular being assigned different priorities taking into account the distance values.

In this case the highest priority level is assigned to the routes with the smallest distance values. Routes with higher distance values and correspondingly lower priority levels can be set up as ‘backup routes’.

In a later transmission from such a network node to the potential destination network node, the priorities can be taken into account and in particular transmission paths with high priorities given precedence.

If different routes with the same distance are available in a network node for a message transfer, route selection can be operated for example simply in ‘load sharing mode’.

According to the invention, a network node which has been made available to the network as a new network node is first registered with its adjacent network nodes as part of a registration request and at the same time the inventive step a.) performed before it is used for forwarding other distance information as part of step b.). By this means a smooth method sequence is supported, in particular where an SS7 network or a comparable network is concerned.

As a result of changes in the network it can happen that a distance to a potential destination network node changes. In order to distribute the corresponding information in the network in such a case, the network node concerned is re-registered in the network by the method described. The corresponding distance information is then updated, for example in the routing table, in the network nodes which receive such a message.

When the M3UA protocol is used, an ‘Application Server Process Up’ (ASP UP) message or, as the case may be, an ‘Application Server Process Up Acknowledgement’ (ASP UP ACK) message is exchanged between network nodes during the connection setup. In order to be able to identify a network node on which the method according to the invention has been implemented in the network, the ASP UP message or the ASP UP ACK message can for example be extended accordingly. For example, an info string containing information on this (e.g. Info String=‘support automatic route configuration’) can be inserted in these messages. The Info String parameter in the ASP UP and ASP UP ACK messages is an optional parameter which is ignored if it has an unknown content.

If a route is no longer to be used for transmissions until further notice, this is notified to the relevant adjacent network nodes by means of a deregistration request.

In comparatively large networks in particular it does not make sense to set up all possible transmission paths also as routes. This would make the route databases unnecessarily large and if the present invention is used would lead to very many registration requests which in practice would have no influence on the route configuration, yet would generate unnecessary data transfer traffic. Since preferably only effective routes are to be used, in other words routes with a short distance, a maximum distance value can be defined. Routes with a distance greater than this maximum distance can therefore be classified as too inefficient. Such routes are then also no longer reported on to adjacent nodes.

Whether it makes sense to define a maximum distance or how great such a distance should be chosen to be is dependent in particular on the structure or, as the case may be, on the requirements of the network. For example, greater distances are required in hierarchically structured networks than in networks which are fully meshed.

A key aim in the setting up of the routing tables is that they can be used to forward each message as quickly as possible to its destination. In any case it is imperative to prevent possible routes being stored as such if their use leads to a message being moved further away from its destination network node or traveling on a looping route—‘in a circular manner’—around the destination network node. For this reason, according to the invention, a network node registers destination network nodes with its adjacent network nodes only if the relevant adjacent network node itself has no smaller distance to this destination. If the relevant adjacent network node has the same distance to the destination, the destination is registered nonetheless so that it will be possible with the aid of this information to set up possible alternate routes.

A further means of protection against route looping is offered by the MTP Level 3 procedure for sending what are known as ‘Preventive Transfer Prohibited’ (preventive TFP) messages or what is known as a ‘Destination Unavailable’ (DUNA) message if the connection is an M3UA connection. A message of this kind is sent to an adjacent network node which is currently being used for routing. This prevents messages being shuttled back and forth between two network nodes and as a result ‘ping-pong routing’ becoming established.

For networks with automatic routing configuration it is possible to extend the Preventive Transfer Prohibited procedure such that Preventive Transfer Prohibited messages are sent not only in respect of those routes which are currently being used, but in respect of all routes which have the same distance to the corresponding destination network node as the routes currently used.

If the automatic configuration of routes according to the present invention is not implemented on all network nodes in a network system, the information on this can be notified during the connection setup of a new STP. This information can be included, for example, in the info string of an ASP UP message. If the info string does not contain this information, it is assumed that the corresponding network node does not have automatic configuration capability.

Alternatively it is also possible to specify by means of a manual configuration which network nodes have the capability to handle the automatic configuration procedure.

An STP or SG also knows without registration which SS7 destination network nodes are directly connected to it by means of an SS7 linkset. As there is a direct SS7 linkset (not via a further STP) to such network nodes, the distance must be one. According to the invention, distance information with the distance value one can therefore also be forwarded to directly adjacent network nodes when the potential destination network node is a network node on which the method according to the invention is not implemented. In this way routing information relating to such potential destination network nodes which are connected directly by means of SS7 links can also be integrated into the method.

For destination network nodes which are not immediately adjacent network nodes and on which the method is not implemented, a default value (e.g. three) can be used, for example, as the distance value. Alternatively it is possible to perform the configuration manually for routes which have such network nodes as potential destination network nodes.

Instead of M3UA registration requests, which are transferred in accordance with the M3UA protocol, it is possible as an alternative to exchange the corresponding information (point code, distance, network appearance) on other paths between the network nodes. For example, the routing information could be exchanged between the SGs via separate Transmission Control Protocol (TCP)/IP connections. In this way it is possible in an SS7 network to integrate STPs which are not interconnected via the M3UA protocol into the automatic route configuration method.

Further features, advantages and characteristics will now be explained with the aid of a detailed description of exemplary embodiments and with reference to the figures of the attached drawings, in which:

### BRIEF DESCRIPTION OF THE DRAWINGS

FIG. 1 shows a registration of a newly set up point code in a network;

FIG. 2 shows a distance of a registered connection;

FIG. 3 shows a re-registration of a point code;

FIG. 4 shows a transmission of a ‘Preventive TFP’ message; and

FIG. 5 shows an extended ‘Preventive TFP’ or DUNA rule.

All the symbols and reference characters are used consistently in the four [sic] figures.

### DETAILED DESCRIPTION OF INVENTION

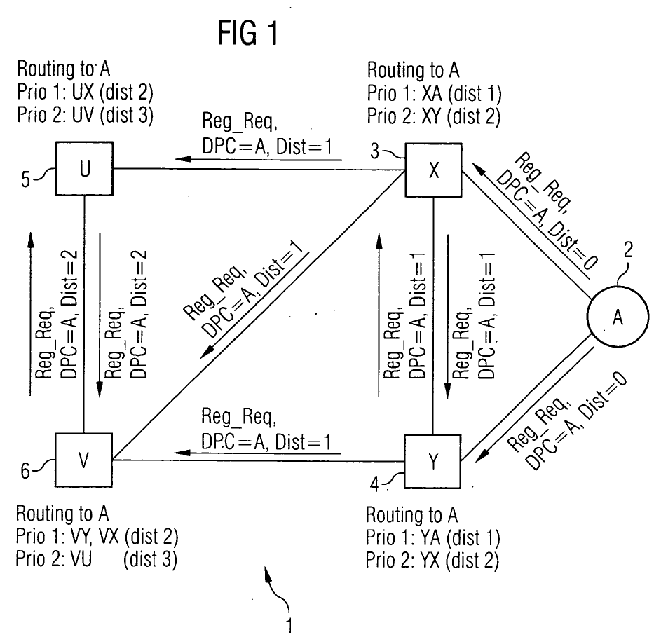

FIG. 1 shows a schematic representation of a telecommunications network 1 which has the five network nodes ‘A’ 2, ‘X’ 3, ‘Y’ 4, ‘U’ 5 and ‘V’ 6 and seven connections (7, 8, 9, 10, 11, 12, 13) between these as elements. In the example shown, the network nodes ‘X’ 3, ‘Y’ 4, ‘U’ 5, ‘V’ 6 are signaling gateways (SGs) which serve as signaling transfer points (STPs). ‘A’ is a signaling end point (SEP), for example a media gateway controller (MGC).

In the following, for the sake of simplicity and greater clarity, the short designation ‘X’ will be used instead of ‘network node ‘X’’ or ‘signaling gateway ‘X’’ and similar short designations will be used for the other network nodes.

Each of the network nodes has an address in the SS7 network which is specified as a point code. In a message transfer, the point code of the destination network node is specified as the address as the destination point code (DPC).

FIG. 1 shows a case in which ‘A’ 2 has been set up as a new MGC in the network and so is available to the network as a new network node, and according to the invention this information is passed on to the other SGs ‘X’ 3, ‘Y’ 4, ‘U’ 5 and ‘V’ 6.

As the first step toward that end, ‘A’ 2 transmits to each of its immediate neighbors ‘X’ 3 and ‘Y’ 4 a message in which the distance from ‘A’ to ‘A’, in other words ‘to itself’, is specified according to the above-cited definition of the distance as zero. This can take place for example when the M3UA protocol is used in the course of a registration request. This is specified below as
‘Reg_Req, DPC=A, Dist=0’

In order to adapt the received distance information to the local situation of the SGs ‘X’ 3 or, as the case may be, ‘Y’ 4, the distance value in each of said SGs is incremented by one, since the distance from ‘X’ 3 to ‘A’ 2 is one, as also is the distance from ‘Y’ 4 to ‘A’ 2. This locally adapted distance information is stored for example in the respective routing databases of the SGs ‘X’ 3 and ‘Y’ 4.

As the distance value ‘one’ represents the smallest possible value for a potential transmission, the highest possible priority (priority one) is assigned to the thus defined—direct—route to ‘A’ 2 in ‘X’ 3 and ‘Y’ 4. This is stored in the routing database of ‘X’ 3 for example in the form

Routing to A

Prio 1: XA (dist 1)
   where ‘XA’ serves to express that ‘A’ 3 should be selected as the next network node on this route by ‘X’ 3.

As the next step, the information thus stored and processed is forwarded from the SGs ‘X’ 3 and ‘Y’ 4 to further adjacent SGs. Using the above-cited short notation, the corresponding message from ‘X’ 3 to ‘Y’ 4 looks like this:
Reg_Req, DPC=A, Dist=1

This distance information is in turn incremented and stored in ‘Y’ 4. Since the path from ‘Y’ 4 via ‘X’ 3 to ‘A’ 2 is further than the direct path, the route ‘YX’ is assigned a lower priority, with the result that the routing database of ‘Y’ 4 finally contains:

Routing to A

Prio 1: YA (dist 1)
Prio 2: YX (dist 2)
   and, analogously, the routing database of ‘X’ 3 contains:
   Routing to A
Prio 1: XA (dist 1)
Prio 2: XY (dist 2)
   In addition, ‘X’ 3 sends to ‘U’ 5:
Reg_Req, DPC=A, Dist=1

The same message is also transmitted from ‘X’ 3 to ‘V’ 6. It is processed and registered in ‘U’ 5 and ‘V’ 6 according to the above-described method. The result is that after this step the following information is present for example in the routing database in ‘U’ 5:

Routing to A

Prio 1: UX (dist 2)

In the example shown, ‘X’ 3 sends the distance information to all its immediately adjacent SGs, except to ‘A’ 2, since the distance value zero is present in ‘A’ 2 for the route to ‘A’ 2, whereas in ‘X’ 3 the distance value for the route to ‘A’ 2 is one, in other words a greater value is present and according to the invention no distance information is transmitted in this case.

Furthermore, according to the inventive method ‘U’ 5 sends the following to its neighbor ‘V’:
Reg_Req, DPC=A, Dist=2

Once again this message is not transmitted to ‘X’ 3, since ‘X’ 3 already has a route with a shorter distance to ‘A’ 2.

Once all the distance information has been distributed according to the method, the routing database of ‘U’ 5 finally contains:

Routing to A

Prio 1: UX (dist 2)
Prio 2: UV (dist 3)
   and the routing database of ‘V’ 6 then contains:
   Routing to A
Prio 1: VX, VY (dist 2)
Prio 2: VU (dist 3)

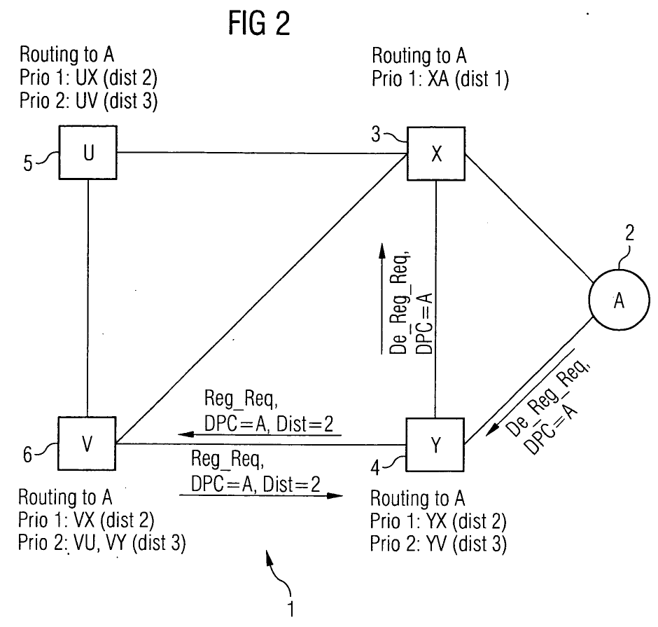

FIG. 2 shows the case where a deregistration request is used to circulate in the network the information that a previously registered route is no longer available. All the symbols and designations have the same meaning as in FIG. 1 unless expressly stated otherwise.

In the example shown, the starting point is the situation which exists following completion of the example sequence represented in FIG. 1. The route which is no longer available in the example shown is the sublink between ‘A’ 2 and ‘Y’ 4. This information is transmitted in the first step from ‘A’ 2 by means of a deregistration request to ‘Y’ 4, whereupon the route
Prio 1: YA (dist 1)
   is deleted without replacement in ‘Y’ 4. In the routing database of ‘Y’ 4 there thus remains for the potential destination SG ‘A’ 2:
   Routing to A
Prio 1: YX (dist 2)
Prio 2: YV (dist 3)

As ‘one’ was transmitted in a preceding step (see FIG. 1) by ‘Y’ 4 to its adjacent network nodes as the distance value to ‘A’ 2, this information now needs to be updated. ‘Y’ 4 therefore transmits two to ‘V’ 6 as the new distance value to ‘A’ 2. It is thus registered in ‘V’ 6 that the distance value to ‘A’ 2 for the route via ‘Y’ 4 is increased from two to three and the priority of the route ‘VY’ to ‘A’ 2 is reduced accordingly by one in the routing table of ‘V’ 6.

Up to this time ‘V’ 6 has offered no route for the potential destination ‘A’ 2 to ‘Y’ 4, since the distance from ‘Y’ 4 to ‘A’ 2 was shorter than the distance from ‘V’ 6 to ‘A’ 2. As this is now no longer the case, ‘V’ 6 can now also offer a route to ‘A’ 2 for ‘Y’ 4 and the following is therefore sent from ‘V’ 6 to ‘Y’ 4:
Reg_Req, DPC=A, Dist=2

Since the distance between ‘X’ 3 and ‘A’ 2 is one and the distance between ‘Y’ 4 and ‘A’ 2 is now two and therefore greater, no route to ‘A’ is made available by ‘Y’ 4 for ‘X’ 3. Thus, an update of this route is not possible in this case and therefore the route to ‘A’ 2 is deregistered with ‘X’ 3 by ‘Y’ 4. In other words, ‘Y’ 4 sends the following to ‘X’ 3:
DeReg_Req, DPC=A

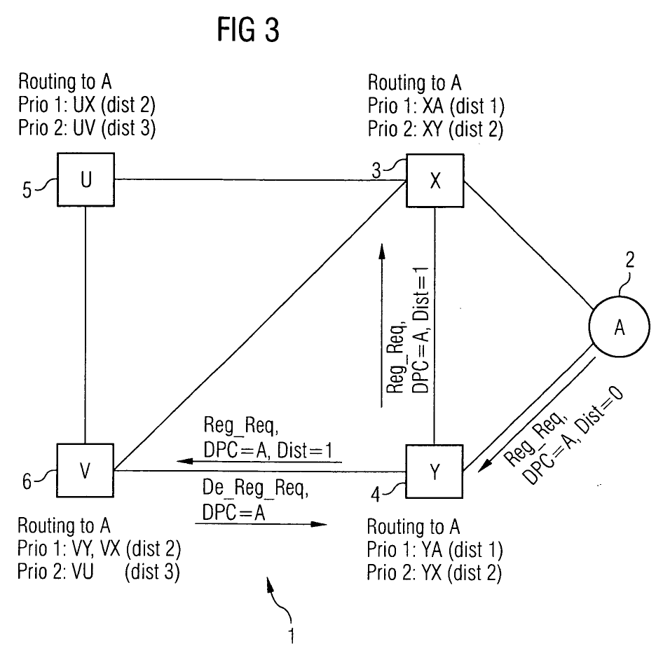

FIG. 3 shows the procedure for a re-registration of ‘A’ 2 with ‘Y’ 4, starting from the end status of the process illustrated in FIG. 2. First, a new registration request is sent to ‘Y’ 4 by ‘A’ 2:
Reg_Req, DPC=A, Dist=0

This is registered in ‘Y’ 4 and therefore ‘YA’ is stored as a new possible route to ‘A’ 2 with the distance one. This route is assigned the highest priority.

As the distance between ‘Y’ 4 and ‘A’ 2 has now been shortened again, this new distance value is sent by ‘Y’ 4 to ‘V’ 6:
Reg_Req, DPC=A, Dist=1

Since ‘Y’ 4 has a smaller distance to ‘A’ 2 than ‘V’ 6, a deregistration request is sent by ‘V’ 6 to ‘Y’ 4:
De_Reg_Req, DPC=A

As ‘Y’ 4 to ‘A’ 2 now also has the same distance again as ‘X’ 3 to ‘A’ 2, ‘Y’ 4 can again offer a route to ‘A’ 2 for ‘X’ 3:
Reg_Req, DPC=A, Dist=1

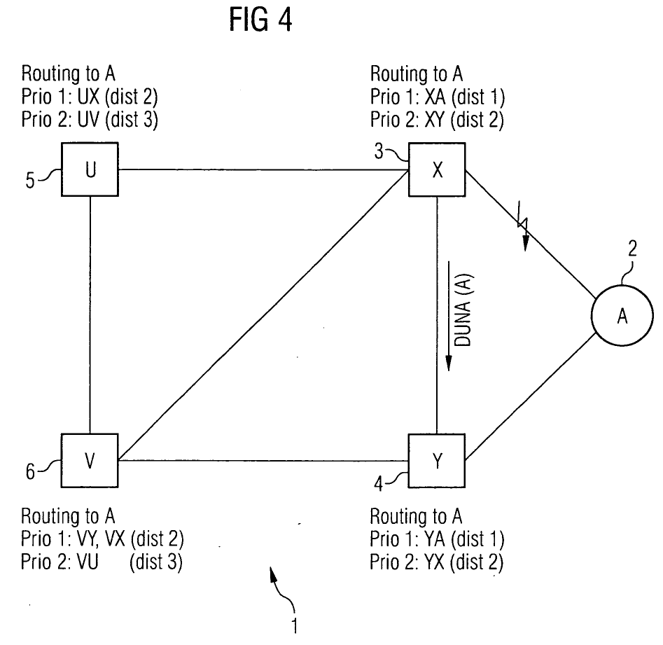

FIG. 4 shows the transmission of a ‘Preventive TFP’ message or, as the case may be, DUNA message as a means of preventing ‘ping-pong routing’. In this case the situation which prevailed following completion of the sequence illustrated in FIG. 1 is chosen as the starting situation.

Usually ‘X’ 3 sends a message with the destination ‘A’ 2 via the route with the highest priority, in other words ‘XA’. If the sublink between ‘X’ 3 and ‘A’ 2 fails, messages are transmitted from ‘X’ 3 to ‘A’ 2 via ‘Y’ 4.

In order to prevent messages intended for ‘A’ 2 now being sent back on its part from ‘Y’ 4 via the connection ‘YX’, a TFP or DUNA message relating to ‘A’ 2 is sent by ‘X’ 3 to ‘Y’ 4. By means of this message it is made known to ‘Y’ 4 that the connection ‘YX’ should no longer be used for a transmission with destination ‘A’ 2 until further notice. This remains valid until ‘X’ 3 sends another TFA message.

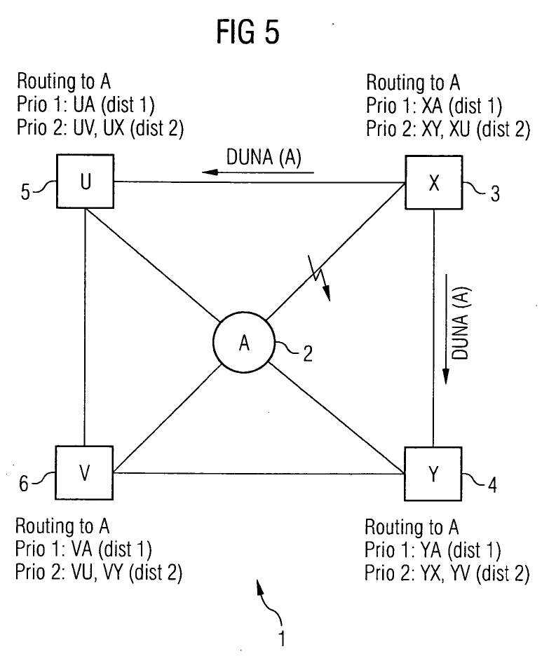

FIG. 5 shows an extended ‘Preventive TFP’ or DUNA rule. The starting situation is as follows: The SGs ‘X’ 3, ‘Y’ 4, ‘U’ 5 and ‘V’ 6 each have a direct connection to ‘A’ 2 and at the same time are in each case connected to two immediately adjacent SGs, via which two alternate routes with the distance two, in other words of lower priority, lead in each case.

If all the sublinks to ‘A’ 2 fail, in the worst case this could give rise to ‘loop routing’, whereby a message intended for ‘A’ 2 is routed from ‘X’ 3 via ‘U’ 5 further via ‘V’ 6 and ‘Y’ 4 and finally again to ‘X’ 3.

In order to prevent loop routing of this kind, where a message is always forwarded to the destination on connections of the same distance, the ‘Preventive TFP’ rule has been extended. As soon as an SG currently uses a route to ‘A’ 2, a ‘Preventive TFP’ message is sent not only over the currently used route, but also on all those routes to ‘A’ 2 which have the same distance as the currently used route.

1-26. (canceled)

27. A method for determining topological features of a packet-based network having a plurality of network nodes, wherein a distance between two network nodes is determined by the number of sublinks lying between them, the method comprising:
a.) transmitting a registration message from a first network node to at least one immediately adjacent receiving network node, wherein the message including distance information;
b.) incrementing a value of the distance information by the at least one receiving network node, with the result that the incremented value is equal to the number of sublinks lying between the message-receiving network node and the message-transmitting first network node;
c.) locally storing the incremented value of the distance information in the at least one receiving network node; and
d.) forwarding the message with the thus modified distance value to at least one further immediately adjacent network node, wherein
the steps b.) to d.) being repeated until a defined abort criterion is reached.

28. The method according to claim 27, wherein the network nodes participating in the method to some extent fulfill the function of signaling transfer points and/or to some extent fulfill the function of signaling end points.

29. The method according to claim 27, wherein the distance information messages are transmitted by a message transfer part of a protocol or of a protocol family.

30. The method according to claim 27, wherein in step d.) another distance value is sent instead of the modified distance value if the other distance value
(i) relates to the same first sending network node as the modified distance value,
(ii) is stored in the at least one receiving network node, and
(iii) the other distance value is less than the modified distance value.

31. The method according to claim 27, wherein in the at least one receiving network node, if at least two items of distance information which identify at least two different routes to the first sending network node are present, these routes are classified as a function of their respective distance.

32. The method according to claim 27, wherein in the at least one receiving network node, if at least two classified routes are present, the corresponding distance information is taken into account in a route selection taking place in a following step.

33. The method according to claim 27, wherein step a.) is performed first for a network node before this network node is used as at least one receiving network node for a step b.).

34. The method according to claim 27, wherein in step d.) the message is not forwarded to a further immediately adjacent network node if the distance from the further immediately adjacent network node to the first sending network node is less than the distance from the receiving network node in the preceding step b.) to the first sending network node.

35. The method according to claim 27, wherein in a further step a deregistration message is sent by a second sending network node to at least one network node immediately adjacent to said second network node, said deregistration message including information about a route which is no longer to be used for message transfer in the network until further notice.

36. The method according to claim 27, wherein the message is only forwarded if the value of the distance lies below a predetermined threshold.

37. The method according to claim 27, wherein the first sending network node sends, together with the distance information, a further item of information relating to a route selection.

38. The method according to claim 27, wherein the further information is taken into account by the at least one receiving network node for a future route selection.

39. The method according to claim 27, wherein in a step preceding step a.) a message is sent containing information which indicates whether the method according to claim 27 is implemented on the first sending network node and that this information is distributed further in the network in accordance with steps b.) to d.) and where applicable their repetitions.

40. A method for setting up a routing database in a packet-based network having a plurality of network nodes, wherein the distance between two network nodes is determined by the number of sublinks located between them, the method comprising the following steps:
a.) transmitting a registration message having distance information from a first network node to at least one immediately adjacent receiving network node;
b.) incrementing the value of the distance information by the at least one receiving network node, with the result that the incremented value is equal to the number of sublinks lying between the message-receiving network node and the message-transmitting first network node;
c.) locally storing the incremented value of the distance information, the network address of the first sending network node, and the network address of the network node from which the distance information was last sent in the at least one receiving network node; and
d.) forwarding the message with the thus modified distance value to at least one further immediately adjacent network node, wherein
the steps b.) to d.) being repeated until a defined abort criterion is reached.

41. The method according to claim 40, wherein the network nodes participating in the method to some extent fulfill the function of signaling transfer points and/or to some extent fulfill the function of signaling end points.

42. The method according to claim 40, wherein the distance information messages are transmitted by a message transfer part of a protocol or of a protocol family.

43. The method according to claim 40, wherein in step d.) another distance value is sent instead of the modified distance value if the other distance value
(i) relates to the same first sending network node as the modified distance value,
(ii) is stored in the at least one receiving network node, and
(iii) the other distance value is less than the modified distance value.

44. The method according to claim 40, wherein in the at least one receiving network node, if at least two items of distance information which identify at least two different routes to the first sending network node are present, these routes are classified as a function of their respective distance.

45. The method according to claim 40, wherein in the at least one receiving network node, if at least two classified routes are present, the corresponding distance information is taken into account in a route selection taking place in a following step.

46. The method according to claim 40, wherein step a.) is performed first for a network node before this network node is used as at least one receiving network node for a step b.).

47. The method according to claim 40, wherein in step d.) the message is not forwarded to a further immediately adjacent network node if the distance from the further immediately adjacent network node to the first sending network node is less than the distance from the receiving network node in the preceding step b.) to the first sending network node.

48. The method according to claim 40, wherein in a further step a deregistration request is sent by a second sending network node to at least one network node immediately adjacent to said second network node, said deregistration request including information about a route which is no longer to be used for message transfer in the network until further notice.

49. The method according to claim 40, wherein the message is only forwarded if the value of the distance lies below a predetermined threshold.

50. The method according to claim 40, wherein the first sending network node sends, together with the distance information, a further item of information relating to a route selection.

51. The method according to claim 40, wherein the further information is taken into account by the at least one receiving network node for a future route selection.

52. The method according to claim 40, wherein in a step preceding step a.) a message is sent containing information which indicates whether the method according to claim 27 is implemented on the first sending network node and that this information is distributed further in the network in accordance with steps b.) to d.) and where applicable their repetitions.
